(19) United States
(12) Patent Application Publication
(10) Pub. No.: US 2006/0046064 A1
(43) Pub. Date: Mar. 2, 2006

(54) Method of improving removal rate of pads

(76) Inventors: Dwaine Halberg, Mesa, AZ (US); Peter Renteln, San Ramon, CA (US)

Correspondence Address: SNELL & WILMER;ONE ARIZONA CENTER, 400 EAST VAN BUREN, PHOENIX, AZ, 850040001, US

(21) Appl. No.: 10/924,831

(22) Filed: Aug. 25, 2004

(51) Int. Cl. D21H 19/54; B32B 27/36; B32B 27/40

(52) U.S. Cl. 428/412; 428/423.1; 524/47

(57) ABSTRACT

A method of improving a removal rate of a pad includes producing a body of a pad of polyurethane from a mix; and introducing into the mix an additive which decreases an elastic rebound of the pad so as to increase a chemical-mechanical planarization removal rate; and using as the additive a substance which at least contains starch.

### BACKGROUND OF THE INVENTION

The present invention relates to a method of increasing a chemical-mechanical planarization removal rate by pads.

The present invention generally relates to polishing pads, in particular for chemical-mechanical polishing (CMP) with the use of a slurry. CMP is a process step in the semiconductor fabrication sequence that has generally become an integral part of the manufacture of semiconductor wafers. The process is used in a variety of applications in the semiconductor fabrication sequence. A summary of the different applications would include that which is referred to as “oxide” or “ILD/PMD”, “STI”, “copper”, “barrier”, “poly” and “tungsten”, the terms generally indicating the material that is being removed. The common theme relating all of these applications is that CMP is required to expediently remove material and planarize the surface, while leaving it defect and contamination free. These applications generally require the use of different slurries, and their mechanism of removal is therefore also generally different. Because of that, the optimal condition of each of the applications tends to be different as well.

In any of these CMP processes, the silicon substrate is forcibly placed in direct contact with a moving polishing pad. A wafer carrier applies pressure against the backside of the substrate, usually while simultaneously forcibly applying rotation. During this process a slurry is made available, and is generally carried between the wafer and the pad by the motion of the pad. The elements contained in the slurry are chosen by the CMP application. In general, slurries that are designed to remove insulating materials consist of water, an abrasive and an alkali formulation designed to “hydrolyze” the insulating material. Copper slurries on the other hand, tend consist of water, an abrasive, an oxidizing agent, a complexing agent, and a chemical to passify the surface. A typical slurry often has very low removal rate on a material it was not designed to remove.

The CMP polishing pad is required to perform a plurality of engineering functions. It is required to polish at a high removal rate, planarize up to a certain planarization length determined by the quality of the silicon substrate, not planarize beyond that length, transport slurry, maintain the same friction with the wafer for wafers polished sequentially and with interruptions for hundreds of wafers, clean the wafer surface, not scratch the wafer surface, be replaceable in minimal time, and others. This invention addresses the removal rate of a pad.

While slurry is a significant factor in the removal rate, several pad-related factors affect the removal rate as well. For example, grooves are a strong factor as the presence of grooves is instrumental in delivering the slurry to the wafer-pad interface, where it is required for the process to be carried out. The pattern, pitch, width and depth of these grooves are generally known to be an important part of the process.

It is also known that removal rate is related to the friction which exists between the wafer and the pad in the presence of the slurry. This friction differs for different pads and can be affected by mechanical factors such as the pore size and density as well as material factors as may be affected by ingredients in the pad.

Generally, the pads used for CMP are anelastic. An anelastic material exhibits both elastic and inelastic properties. A measure of the amount of inelasticity of a material is the Elastic Rebound, or the Elastic Recovery (ER). When compressed and released, the fractional amount of recovery after a set period of time is the ER. The higher the elastic rebound, the more elastic the material, while the lower the elastic rebound the more plastic is the material. It is an essential aspect of this invention that for polyurethane pads and oxide wafers that a chemical mechanical planarization removal rate has been found to be strongly negatively correlated with ER.

The introduction of starch into a urethane mix is known for a variety of purposes. Starch is a known urethane additive, for example to increase biodegradability (e.g. U.S. Pat. No. 6,228,969), improve flame retardance and to enhance foaming, (e.g. U.S. Pat. No. 4,374,208).

### SUMMARY OF THE INVENTION

Accordingly, it is an object of the present invention to provide a method of improving a chemical-mechanical planarization removal rate of the pads.

In keeping with these objects and with others which will become apparent hereinafter, one feature of the present invention resides, briefly stated, in a method of improving a removal rate of a pad, comprising the steps of producing a body of a pad of which at least the top layer is polyurethane; introducing into the body an additive which decreases said ER of the pad so as to increase a chemical-mechanical planarization removal rate; and using as the additive a substance which at least contains starch.

In accordance with still a further feature of the present invention, said using step includes introducing substantially one pound of starch in a 25 pound mix to reduce the elastic rebound by eight percentage points.

When in accordance with the inventive method at least a substance containing starch is introduced into the polyurethane body of the pad, the elastic rebound is significantly decreased, and as a result a chemical-mechanical planarization removal rate of the pad is increased.

It is understood that the pads of this invention can be used for application of process on any of a number of substrates, such as a bare silicon wafer, a semiconductor device wafer, a magnetic memory disk or similar.

Pads of the present invention can be made by any one of a number of polymer processing methods, such as but not limited to, casting, compression, injection molding, extruding, web-coating, extruding, and sintering. At least one layer of the pads may be single phase or multiphase, where the second phase could include polymeric microballoons, gases or fluids. The second phase could also by an abrasive such as silica, alumina, calcium carbonate, ceria, titania, germanium, diamond, silicon carbide or combinations thereof.

The novel features which are considered as characteristic for the present invention are set forth in particular in the appended claims. The invention itself, however, both as to its construction and its method of operation, together with additional objects and advantages thereof, will be best understood from the following description of specific embodiments.

### DESCRIPTION OF THE PREFERRED EMBODIMENTS

In accordance with an inventive method of improving a chemical-mechanical planarization removal rate of pads, first a pad is produced for example from polyurethane in a known manner. For example the pad can include the following composition:
20 lbs ADIPRENE L325 Liquid Polyether Urethane from Crompton Uniroyal
4.7 lbs MOCA (4,4-methylene-bis-chloroaniline)
0.5 lb L-6100 silicone surfactant from GE Silicones

The prepolymer and surfactant components are mixed for a duration 2.5 minutes before the accelerant MOCA is added, and an additional 1 minute afterwards. The mix is then pored into a mold, cured at room temperature for 15 minutes, and placed into an oven at a temperature of 250 deg F. for 8 hours. The cake is then allowed to cool and is sliced with a skiving-type blade. The slices are then fashioned into polishing pads through additional steps such as grooving, applying adhesive and applying a subpad.

In accordance with the new inventive feature of the present invention, at least a starch-containing additive, or a starch is introduced into the liquid mix. The introduction of the at least a starch-containing additive, or starch can be performed as follows:

Mix the starch-containing additive together with the L-325 and the L-6100 and increase the mix time to 5 minutes. Then add the accelerant and continue as described initially.

As an example of the realization of the present invention, one pound of starch can be introduced into the mix, and as a result the Elastic Rebound of the pads are reduced by a full eight absolute percentage points, from 94% to 86%, with an r-square value of 66%.

In a preferred embodiment, 0.5 pound of starch or equivalent can be introduced into the mix, reducing the ER from 94% to 90%.

Since the elastic rebound of the pad is decreased, the chemical mechanical planarization removal rate is correspondingly increased.

It will be understood that each of the elements described above, or two or more together, may also find a useful application in other types of constructions differing from the types described above.

While the invention has been illustrated and described as embodied in method of improving removal rate of pads, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of improving a removal rate of a polishing pad, at least one layer of which is constructed comprising the steps of producing a body of a pad of polyurethane from a mix; introducing into the mix an additive which decreases an elastic rebound of the pad so as to increase a chemical-mechanical planarization removal rate; and using as the additive a substance which at least contains a starch.

2. A polishing pad, at least one layer of which is constructed comprising the steps of producing a body of a pad of polyurethane from a mix; and introducing into the mix an additive which decreases an elastic rebound of the pad so as to increase a chemical-mechanical planarization removal rate; and using as the additive a substance which at least contains a starch.

3. A method as defined in claim 1, wherein said using step includes introducing substantially one pound of starch in a 25 pound mix to reduce the elastic rebound of the pad by eight percentage points.

4. A pad according to claim 1 wherein said layer is a polyether urethane or a polyester polyurethane.

5. A pad according to claim 1 wherein said layer is a polycarbonate.

6. A pad according to claim 1 wherein said layer contains abrasive particles selected from any of silica, alumina, ceria, titania, diamond and silicon carbide.

7. A pad according to claim 1 wherein said layer includes a filler.

8. A pad according to claim 1 wherein said layer is a nylon.

9. A pad according to claim 1 wherein said layer is absent abrasive particles.
